(19) United States
(12) Patent Application Publication
(10) Pub. No.: US 2014/0365695 A1
(43) Pub. Date: Dec. 11, 2014

(54) ELECTRONIC DEVICE WITH MULTIFUNCTIONAL UNIVERSAL SERIAL BUS PORT

(71) Applicants: HONG FU JIN PRECISION INDUSTRY (ShenZhen) CO., LTD, Shenzhen (CN); HON HAI PRECISION INDUSTRY CO., LTD., New Taipei (TW)

(72) Inventors: XIAO-ZHAN PENG, Shenzhen (CN); CHUN-LUNG HUNG, New Taipei (TW)

(73) Assignees: HONG FU JIN PRECISION INDUSTRY (ShenZhen) CO., LTD, Shenzhen (CN); HON HAI PRECISION INDUSTRY CO., LTD., New Taipei (TW)

(21) Appl. No.: 14/300,428

(22) Filed: Jun. 10, 2014

(30) Foreign Application Priority Data
Jun. 11, 2013 (CN) 2013102302849

(51) Int. Cl. G06F 13/362

(52) U.S. Cl. CPC G06F 13/362
USPC 710/110

(57) ABSTRACT

An electronic device with a multifunctional universal serial bus (USB) port is provided. The electronic device includes a USB port, a processing unit, a power module, a master-slave response module, and a power control module. The master-slaver response module is connected between the USB port and the processing unit, and is used to produce a corresponding trigger signal to the processing unit according to a type of an external device connected to the USB port. The power control module is connected between the power module and a voltage pin of the USB port. Therein, the processing unit disables the power control module when receiving a first trigger signal. The processing unit enables the power control module to output the power to the power pin of the USB port when receiving a second trigger signal, thus to power the external device.

### CROSS-REFERENCE TO RELATED APPLICATIONS

This application claims priority to Chinese Patent Application No. 201310200284.9 filed on Jun. 11, 2013 in the China Intellectual Property Office, the contents of which are incorporated by reference herein.

### FIELD

The present disclosure relates to electronic devices, and particularly to an electronic device with a multifunctional universal serial bus (USB) port.

### BACKGROUND

Electronic devices, such as mobile phones and tablet computers, usually include at least one USB port. A USB On-The-Go (OTG) technique enables two portable devices to communicate with each other directly via USB ports. When the two portable devices communicate with each other via the USB ports according to USB OTG technique, one portable device is taken as a master device, and the other portable device is taken as a slave device.

### BRIEF DESCRIPTION OF THE DRAWINGS

Implementations of the present technology will now be described, by way of example only, with reference to the attached figures, wherein:

FIG. 1 is a block diagram of an embodiment of an electronic device with a multifunctional USB port.

FIG. 2 is a circuit diagram of an embodiment of an electronic device with a multifunctional USB port.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “inside” indicates that at least a portion of a region is partially contained within a boundary formed by the object. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising” means “including, but not necessarily limited to”; it specifically indicates open-ended inclusion or membership in a so-described combination, group, series and the like.

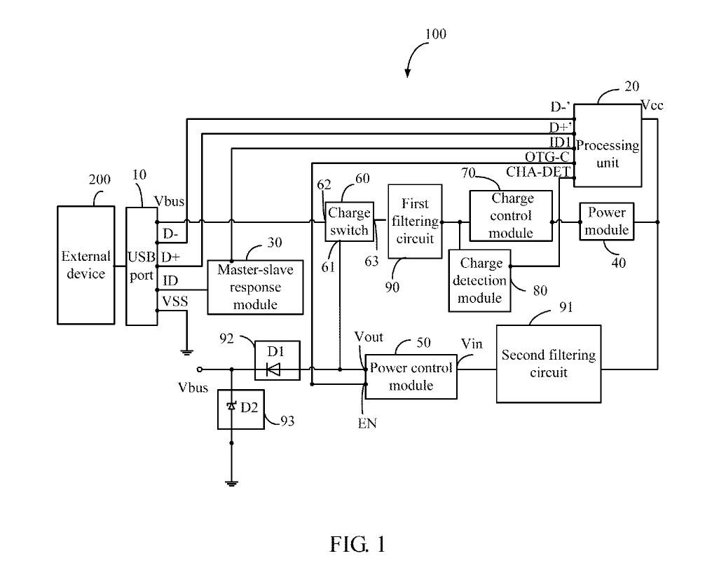

FIG. 1 illustrates a block diagram of an electronic device 100 employing a multifunctional universal serial bus (USB) port. The electronic device 100 includes a USB port 10, a processing unit 20, a master-slave response module 30, a power module 40, a power control module 50, a charge switch 60, and a charge control module 70.

The processing unit 20 includes a voltage pin Vbus, data pins D− and D+, a device pin ID, and a ground pin VSS. The USB port 10 is used to connect to an external device 200.

The processing unit 20 includes data pins D−′ and D+′, a device recognizing pin ID1 and a master-slave control pin OTG-C.

The data pins D−′ and D+′ are respectively connected to the data pins D− and D+ of the USB port 10. The processing unit 20 communicates with the external device 200 connected to the USB port 10 via the data pins D− and D+ of the USB port 10.

The master-slave response module 30 is connected between the device pin ID of the USB port 10 and the device recognizing pin ID1 of the processing unit 20. When the USB port 10 connects to a master device, such as a host computer, the master-slave response module 30 produces a first trigger signal. When the USB port 10 connects to a slave device, the master-slave response module 30 produces a second trigger signal. In the embodiment, when a different external device 200 is connected to the USB port 10, namely the master device or the slave device, the voltage of the device pin ID of the USB port 10 is different. The master-slave response module 30 produces the first trigger signal or the second trigger signal according to the voltage of the device pin ID of the USB port 10.

The power control module 50 includes a voltage input port Vin, a voltage output port Vout, and an enable port EN. The voltage input port Vin is coupled to the power module 40, the voltage output port Vout is coupled to the voltage pin Vbus of the USB port 10. The enable port EN is connected to the master-slave control pin OTG-C. The power control module 50 is used to convert a voltage input from the power module 40 via the voltage input port Vin and then output the converted voltage to the voltage pin Vbus of the USB port 10 via the voltage output port Vout.

The charge switch 60 includes a control terminal 61, a first path terminal 62, and a second path terminal 63. The control terminal 61 is coupled to the voltage output port Vout of the power control module 50. The first path terminal 62 is connected to the voltage pin Vbus of the USB port 10, and the second path terminal 63 is coupled to the charge control module 70. In the embodiment, the charge switch 60 is a low voltage activated switch.

The charge control module 70 is electrically connected between the charge switch 60 and the power module 40, and is used to control to charge the power module 40.

When the device recognizing pin ID1 of the processing unit 20 receives the first trigger signal from the master-slave response module 30, the processing unit 20 determines the external device 200 connected to the USB port 10 is the master device. In addition, the processing unit 20 controls the master-slave control pin OTG-C to output a disable signal to the enable port EN of the power control module 50. Then the power control module 50 is disabled and stops working, the voltage output port Vout of the power control module 50 stops outputting voltage accordingly.

At the same time, the control terminal of the charge switch 60 is at a low voltage (logic 0 voltage) due to no voltage being received from the power control module 50. The charge switch 60 is turned on accordingly. Thus, a voltage received from the voltage pin Vbus of the USB port 10 is output to the charge control module 70 via the charge switch 60, then the charge control module 70 charges the power module 40 according to the received voltage. At this time, the electronic device 100 is taken as the slave device.

When the device recognizing pin ID1 of the processing unit 20 receives the second trigger signal from the master-slave response module 30, the processing unit 20 determines the external device 200 connected to the USB port 10 is the slave device. In addition, the processing unit 20 controls the master-slave control pin OTG-C to output an enable signal to the enable port EN of the power control module 50. Then, the power control module 50 is enabled and in a working state. That is, the power control module 50 converts the voltage output by the power module 40 and outputs the converted voltage to the voltage pin Vbus of the USB port 10 via the voltage output port Vout accordingly. Then, the converted voltage is output to the voltage pin Vbus of the USB port 10 and powers the external device 200 connected to the USB port 10.

At the same time, the control terminal 61 of the charge switch 60 obtains the converted voltage from the power control module 50 and is at high voltage (logic 1 voltage). Thus, the charge switch 60 is turned off accordingly, the charge control module 70 stops receiving the voltage from the USB port 10 and stops charging the power module 40 accordingly. Therefore, at this time, the electronic device 100 is taken as the master device.

In the embodiment, the electronic device 100 further includes a charge detection module 80 and the processing unit 20 further comprises a charge detection pin CHA-DET. The charge detection module 80 is electrically connected between a second path terminal 63 of the charge switch 60 and the charge detection pin CHA-DET of the processing unit 20. When the charge switch 60 is turned on, the charge detection module 80 detects a logic 1 voltage and outputs a charge signal to the charge detection pin CHA-DET of the processing unit 20. The processing unit 20 determines the electronic device 100 is in a charging state when the charge detection pin CHA-DET of the processing unit 20 receives the charge signal.

When the charge switch 60 is turned off, the charge detection module 80 does not detect the logic 1 voltage and outputs an off signal to the charge detection pin CHA-DET of the processing unit 20. The processing unit 20 determines the electronic device 100 is not in the charging state when the charge detection pin CHA-DET of the processing unit 20 receives the off signal.

In another embodiment, the processing unit 20 determines whether the external device 200 that is connected to the USB port 10 is the master device or the slave device further based on the signal received by the charge detection pin CHA-DET of the processing unit 20. Namely, the processing unit 20 determines the external device 200 that is connected to the USB port 10 is the master device when determining the device recognizing pin ID1 of the processing unit 20 receives the first trigger signal and charge detection pin CHA-DET receives the charge signal. Similarly, the processing unit 20 determines the external device 200 connected to the USB port 10 is the slave device when determining the device recognizing pin ID1 of the processing unit 20 receives the second trigger signal and charge detection pin CHA-DET receives the off signal.

In the embodiment, the electronic device 100 further includes a first filtering circuit 90 and a second filtering circuit 91. The first filtering circuit 90 is electrically connected between the second path terminal 63 of the charge switch 60 and the charge control module 70, and is used to filter the voltage output by the voltage pin Vbus when the charge switch 60 is turned on. The second filtering circuit 91 is electrically connected between the power module 40 and the charge control module 50, and is used to filter the voltage output by the power module 40.

The electronic device 100 further includes a protection element 92, the protection element 92 is a diode D1. An anode of the diode D1 is connected to the voltage output port Vout of the power control module 50 and a cathode of the diode D1 is connected to the voltage pin Vbus of the USB port 10. The protection element 92 prevents turning off the charge switch 60 when the USB port 10 is connected to the external device 200 and functioning as the master device or a charger (not shown).

In the embodiment, the electronic device 100 further includes a voltage regulator 93. In the embodiment, the voltage regulator 93 is a voltage regulator diode D2, a cathode of the diode D2 is connected to the voltage output port Vout of the power control module 50, and an anode of the diode D2 is grounded. The voltage regulator 93 is used to stabilize the voltage output by the voltage output port Vout of the power control module 50.

Therefore, in the embodiment, no matter if the electronic device 100 is taken as the master device or the slave device, there is only one USB port 10 needed.

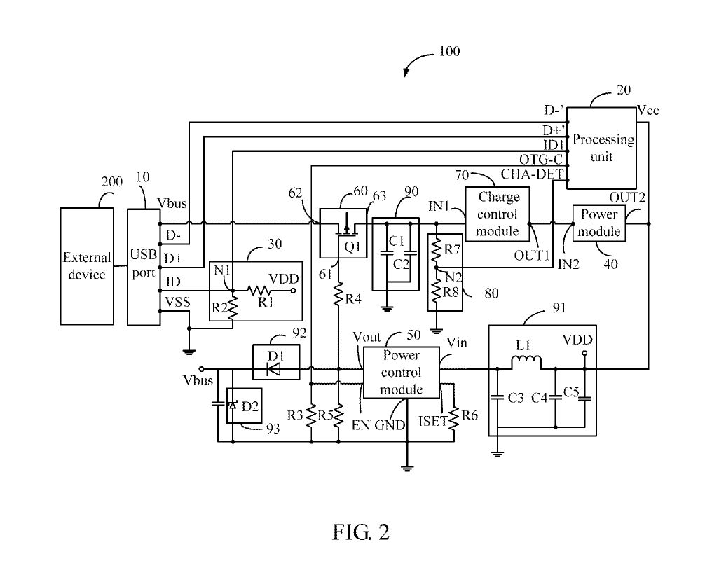

FIG. 2 illustrates a circuit diagram of the electronic device 100. The master-slave response module 30 includes resistors R1 and R2 connected between a voltage port VDD and ground in series. A connection node N1 of the resistor R1 and the resistor R2 is coupled to both the device pin ID of the USB port 10 and the device recognizing pin ID1 of the processing unit 20. The connection node N1 constitutes an output port (not shown) of the master-slave response module 30, and the master-slave response module 30 outputs the first trigger signal or the second trigger signal to the device recognizing pin ID1 of the processing unit 20 via the connection node N1. In the embodiment, the voltage port VDD can connect to the power module 40 and has a logic 1 voltage, such as 5 volts provided by the power module 40.

In the embodiment, after the master-slave control pin of the processing unit is connected to the enable pin of the power control module, the master-slave control pin OTG-C of the processing unit 20 and the enable port EN of the power control module 50 both connect to a ground via a resistor R3.

In the embodiment, the charge switch 60 is a p-channel metal-oxide-semiconductor field effect transistor (PMOSFET) Q1. A gate, a source, and a drain of the PMOSFET Q1 respectively constitute the control terminal 61, the first path terminal 62, and the second path terminal 63 of the charge switch 60.

In another embodiment, the charge switch 60 can be a positive-negative-positive (pnp) bipolar junction transistor (BJT). A base, an emitter, and a collector of the pnp BJT respectively constitute the control terminal 61, the first path terminal 62, and the second path terminal 63 of the charge switch 60.

The voltage output port Vout of the power control module 50 is connected to the gate of the PMOSFET Q1 via a resistor R4, and is further connected to ground via a resistor R5.

In the embodiment, the power control module 50 further includes a current setting port ISET connected to a ground via a resistor R6. In the embodiment, the voltage output by the voltage output port Vout is proportional to a current flowing through the resistor R6 and a voltage output by the current setting port ISET is constant, therefore, the voltage output by the voltage output port can be adjusted by changing a resistance value of the resistor R6. In detail, the resistor R6 can be an adjustable resistor.

The charge control module 70 includes an input port IN1 and an output port OUT1, the power module 40 includes an input port IN2 and an output port OUT2. The input port IN1 of the charge control module 40 is connected to the drain of the PMOSFET Q1, and the output port OUT1 of the charge control module 40 is connected to the input port IN2 of the power module 40. The output port OUT2 of the power module 40 is electrically connected to the voltage input port Vin of the power control module 50 and a voltage port VCC of the processing unit, thus providing power to the power control module 50 and the processing unit.

In the embodiment, the power module 40 can be a battery (not shown), and the input port IN2 and the output port OUT2 both are an anode port of the battery. In another embodiment, the power module 40 can be a power convertor.

In the embodiment, the first trigger signal output by the master-slave response module 30 is a logic 1 voltage signal. The second trigger signal output by the master-slave response module 30 is a logic 0 voltage signal. The enable signal output by the master-slave control pin OTG-C of the processing unit 20 is a logic 1 voltage signal, and the disable signal output by the master-slave control pin OTG-C of the processing unit 20 is a logic 0 voltage signal, the power control module 50 is enabled when the enable port EN is at logic 1 voltage. Therefore, the power control module 50 is enabled when the enable port EN receives the enable signal with logic 1 voltage.

When the external device 200 connected to the USB port 10 is the master device, the device pin ID of the USB port 10 obtains a logic 1 voltage from the external device 200, and the connect node N1 also obtains the logic 1 voltage and outputs the first trigger signal with the logic 1 voltage to the device recognizing pin ID1 of the processing unit 20.

As described above, when the device recognizing pin ID1 of the processing unit 20 receives the first trigger signal with the logic 1 voltage, the processing unit 20 outputs the disable signal with the logic 0 voltage to the enable port EN of the power control module 50 via the master-slave control pin OTG-C, thus disabling the power control module 50. The power control module 50 stops outputting voltage via the voltage output port Vout accordingly.

At this time, the gate of the PMOSFET Q1 is grounded via the resistors R4 and R5 and is at logic 0 voltage, thus the PMOSFET Q1 is turned on accordingly. The external device 200 provides voltage to the input port IN1 of the charge control module 70 via the USB port 10 and the PMOSFET Q1 which is turned on. The charge control module 70 then charges the power module 40 according to the voltage received by the input port IN1.

At this time, the data pins D−′ and D+′ of the processing unit 20 communicate with the external device 200 functioning as the master device via the data pins D− and D+ of the USB port 10. Therefore, when the external device 200 is functioning as the master device and the electronic device 100 is functioning as the slave device, the external device 200 provides power to the electronic device 100 and communicates with the electronic device 100.

When the external device 200 connected to the USB port 10 is the slave device, the external device 200 does not output voltage to the USB port 10, then the device pin ID of the USB port 10 is at logic 0 voltage, and the connect node N1 obtains the logic 0 voltage and outputs the second trigger signal with the logic 0 voltage to the device recognizing pin ID1 of the processing unit 20.

As described above, when the device recognizing pin ID1 of the processing unit 20 receives the second trigger signal with the logic 0 voltage, the processing unit 20 outputs the enable signal with the logic 1 voltage to the enable port EN of the power control module 50 via the master-slave control pin OTG-C, thus enabling the power control module 50. The power control module 50 is in a working state and outputs the voltage to the voltage pin Vbus of the USB port 10 via the voltage output port Vout accordingly.

At this time, the gate of the PMOSFET Q1 obtains the voltage from the voltage output port Vout of the power control module 50 and is at logic 1 voltage, thus the PMOSFET Q1 is turned off accordingly.

At this time, the data pins D−′ and D+′ of the processing unit 20 also communicate with the external device 200 functioning as the slave device via the data pins D− and D+ of the USB port 10. Therefore, when the external device 200 is functioning as the slave device and the electronic device 100 is functioning as the master device, the external device 200 is powered by the electronic device 100 and communicates with the electronic device 100.

The charge detection module 80 includes resistors R7 and R8 connected between the input port IN1 of the charge control module 70 and grounded in series. A connection node N2 of the resistor R7 and the resistor R8 is connected to the charge detection pin CHA-DET of the processing unit 20. In the embodiment, the charge signal output by the charge detection module 80 is a logic 1 voltage signal, and the off signal output by the charge detection module 80 is a logic 0 voltage signal.

When the PMOSFET Q1 is turned on, the connection node N2 obtains the logic 1 voltage from the voltage pin Vbus of the USB port 10 and outputs the charge signal with the logic 1 voltage to the charge detection pin CHA-DET of the processing unit 20. When the PMOSFET Q1 is turned off, the connection node N2 is grounded via the resistor R8 and is at logic 0 voltage, and then outputs the off signal with the logic 0 voltage to the charge detection pin CHA-DET of the processing unit 20.

The first filtering circuit 90 includes capacitors C1 and C2 connected in parallel between the drain of the PMOSFET Q1 and ground. The second filtering circuit 91 includes an inductor L1 and capacitors C3-C5, the inductor L1 and the capacitors C3-C5 constitute a LC filter.

The electronic device 100 and the external device 200 can be mobile phones, tablet computers, portable computers, digital cameras, or digital photo frames. The kind of the electronic device 100 and the external device 200 can be the same as or different.

The electronic device 100 also can include other electronic components, because the electronic components are unrelated with the present disclosure, and the description of these electronic components are omitted herein.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. An electronic device with a multifunctional universal serial bus (USB) port comprising:
a USB port configured to connect to an external device, wherein the USB port comprises a voltage pin, a device pin, and a ground pin;
a processing unit comprising a device recognizing pin and a master-slave control pin;
a master-slave response module connected between the device pin of the USB port and the master-slave control pin of the processing unit, and configured to produce a first trigger signal to the master-slave control pin of the processing unit when the USB port is connected to the external device which is a master device, and produces a second trigger signal to the master-slave control pin of the processing unit when the USB port is connected to the external device which is a slave device;
a power module;
a power control module comprising a voltage input port, a voltage output port, and an enable port, wherein the voltage input port is coupled to the power module, the voltage output port is coupled to the voltage pin of the USB port, the enable port is coupled to the master-slave control pin of the processing unit, the power control module is configured to convert a voltage input from the power module via the voltage input port and output the converted voltage to the voltage pin of the USB port via the voltage output port;
a charge switch comprising a control terminal, a first path terminal, and a second path terminal, wherein, the control terminal is coupled to the voltage output port of the power control module, the first path terminal is coupled to the voltage pin of the USB port, and the charge switch is a low voltage activated switch; and
a charge control module connected between the second path terminal of the charge switch and the power module, and configured to control to charge the power module;
wherein, when the device recognizing pin of the processing unit receives the first trigger signal from the master-slave response module, the processing unit determines the USB port is connected to the master device, and controls the master-slave control pin to output a disable signal to the enable port of the power control module to disable the power control module, the charge switch is turned on accordingly, and the charge control module charges the power module according to a voltage received from the voltage pin of the USB port via the charge switch which is turned on; when the device recognizing pin of the processing unit receives the second trigger signal from master-slave response module, the processing unit determines the USB port is connected to the slave device, and controls the master-slave control pin output an enable signal to the enable port of the power control module to enable the power control module to output voltage to the voltage pin of the USB port, and the charge switch is turned off due to the control terminal receives the voltage from the voltage output port of the power control module.

2. The electronic device according to claim 1, wherein the USB port further comprises two data pins, and the processing unit further comprises two data pin connected to the two data pins of the USB port, when the USB port is connected to the external device, the processing unit communicates with the external device via the data pins of the USB port.

3. The electronic device according to claim 1, further comprising a charge detection module, wherein the processing unit further comprises a charge detection pin, the charge detection module is electrically connected between a second path terminal of the charge switch and the charge detection pin of the processing unit; when the charge switch is turned on, the charge detection module detects a logic 1 voltage and output a charge signal to the charge detection pin of the processing unit, the processing unit determines the electronic device is at a charging state when the charge detection pin of the processing unit receives the charge signal; when the charge switch is turned off, the charge detection module does not detects the logic 1 voltage and output an off signal to the charge detection pin of the processing unit, the processing unit determines the electronic device is not at the charging state when the charge detection pin of the processing unit receives the off signal.

4. The electronic device according to claim 3, wherein the processing unit determines the USB port is connected to the master device when determining the device recognizing pin of the processing unit receives the first trigger signal and charge detection pin receives the charge signal; the processing unit determines the USB port is connected to the slave device when determining the device recognizing pin of the processing unit receives the second trigger signal and the charge detection pin receives the off signal.

5. The electronic device according to claim 1, further comprising a first filtering circuit and a second filtering circuit, wherein the first filtering circuit is electrically connected between the second path terminal of the charge switch and the charge control module, and is configured to filter the voltage output by the voltage pin when the charge switch is turned on; the second filtering circuit is electrically connected between the power module and the charge control module, and is configured to filter the voltage output by the power module.

6. The electronic device according to claim 1, wherein the master-slave response module comprises a first resistor and a second resistor connected between a voltage port and ground in series, a connection node of the first resistor and the second resistor is connected to both of the device pin of the USB port and the device recognizing pin of the processing unit.

7. The electronic device according to claim 6, wherein after the master-slave control pin of the processing unit is connected to the enable pin of the power control module, the master-slave control pin of the processing unit and the enable pin of the power control module both connect to ground via a third resistor.

8. The electronic device according to claim 7, wherein the charge switch is a p-channel metal-oxide-semiconductor field effect transistor (PMOSFET), a gate, a source, and a drain of the PMOSFET respectively constitute the control terminal, the first path terminal, and the second path terminal of the charge switch; the voltage output port of the power control module is connected to the gate of the PMOSFET via a fourth resistor, and is further connected to ground via a fifth resistor.

9. The electronic device according to claim 1, wherein the power control module further comprises a current setting port connected to ground via a sixth resistor, the voltage output by the voltage output port of the power control module is proportional to a current flowing through the sixth resistor and a voltage output by the current setting port is constant, the voltage output by the voltage output port is adjusted by changing a resistance value of the sixth resistor.

10. The electronic device according to claim 8, wherein the first trigger signal output by the master-slave response module is a logic 1 voltage signal, the second trigger signal output by the master-slave response module is a logic 0 voltage signal; the enable signal output by the master-slave control pin of the processing unit is a logic 1 voltage signal, and the disable signal output by the of the processing unit is a logic 0 voltage signal, the power control module is enabled when the enable pin EN is at logic 1 voltage.

11. The electronic device according to claim 10, wherein when the USB port is connected to the master device, the device pin of the USB port obtains a logic 1 voltage from the external device, and the connect node of the first resistor and the second resistor also obtains the logic 1 voltage and output the first trigger signal with the logic 1 voltage to the device recognizing pin of the processing unit, the processing unit then outputs the disable signal with the logic 0 voltage to the enable pin of the power control module via the master-slave control pin, thus to disable the power control module; at the same time, the gate of the PMOSFET is grounded via the fourth resistor and the fifth resistor and is at logic 0 voltage, thus the PMOSFET is turned on accordingly, the charge control module receives voltage provided by the external device via the USB port and the PMOSFET which is turned on, the charge control module then charges the power module according to the received voltage.

12. The electronic device according to claim 10, wherein when the USB port is connected to the slave device, the device pin of the USB port is at logic 0 voltage, and the connect node of the first resistor and the second resistor obtains the logic 0 voltage and output the second trigger signal with the logic 0 voltage to the device recognizing pin of the processing unit, the processing unit then outputs the enable signal with the logic 1 voltage to the enable pin of the power control module via the master-slave control pin, thus to enable the power control module to output the voltage to the voltage pin of the USB port via the voltage output port, at this time, the gate of the PMOSFET obtains the voltage from the voltage output port of the power control module and is at logic 1 voltage, thus the PMOSFET is turned off accordingly.

13. The electronic device according to claim 3, wherein the charge detection module comprises a seventh resistor and a eighth resistor connected between the charge control module and ground in series, a connection node of the seventh resistor and the eighth resistor is connected to the charge detection pin of the processing unit, when the PMOSFET is turned on, the connection node of the seventh resistor and the eighth resistor obtains the logic 1 voltage from the voltage pin of the USB port and outputs the charge signal with the logic 1 voltage to the charge detection pin of the processing unit; when the PMOSFET is turned off, the connection node of the seventh resistor and the eighth resistor is grounded via the eighth resistor and is at logic 0 voltage, and then outputs the off signal with the logic 0 voltage to the charge detection pin of the processing unit.

14. The electronic device according to claim 1, further comprising a protection element, wherein the protection element comprises a first diode, an anode of the diode is connected to the voltage output port of the power control module and a cathode of the diode is connected to the voltage pin of the USB port.

15. The electronic device according to claim 1, further comprising a voltage regulator, wherein the voltage regulator comprises a voltage regulator diode, a cathode of the voltage regulator diode is connected to the voltage output port of the power control module, an anode of the voltage regulator diode is grounded.

16. The electronic device according to claim 5, wherein the first filtering circuit comprises a first capacitor and a second capacitor connected between the control terminal of the charge switch and ground in parallel; the second filtering circuit comprises an inductor, a third capacitor, a fourth capacitor, and a fifth capacitor, the inductor, the third capacitor, the fourth capacitor, and the fifth capacitor constitute a LC filter.
